(19) United States
(12) Patent Application Publication
(10) Pub. No.: US 2009/0100523 A1
(43) Pub. Date: Apr. 16, 2009

(54) SPAM DETECTION WITHIN IMAGES OF A COMMUNICATION

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 10/835,111

(22) Filed: Apr. 30, 2004

(51) Int. Cl. G06F 21/00; G06K 9/00; H04N 1/00

(52) U.S. Cl. 726/26; 382/176; 358/400

(57) ABSTRACT

Determining undesirable, or “spam” communication, by reviewing and recognizing portions within the communications that are things other than ASCII or text. Images are analyzed to determine whether the content of the images is likely to represent undesired content. The images can be classified as to type, can be OCRed, and the contents of the recognition used for analysis, and can be compared against similar images in a database.

### BACKGROUND

It is well known to scan incoming e-mail to determine the presence of undesired and/or unsolicited e-mail, also known as “spam”. For conciseness, the word “spam” will be used throughout this description, it being understood that “spam” refers to any undesired and/or unsolicited e-mail or other electronic communication of any type, including faxes, instant messages or others.

Various techniques are known for determining the presence of spam, using Bayesian analysis, and also heuristically. However, the purveyors of spam also have taken countermeasures to bypass these conventional detection techniques.

### SUMMARY

The present technique describes scanning contents of communications which contents are not in machine readable text form, to determine the presence of specified content within those non-ASCII portions.

One particular aspect looks for portions of communications which will be displayed to a user. The contents of those portions, such as image contents, are then scanned to determine whether the image contents include an undesirable portion. An embodiment describes doing this in emails.

### BRIEF DESCRIPTION OF THE DRAWINGS

These and other aspects will now be described in detail with reference to the accompanying drawings, wherein:

FIG. 1 shows a basic flowchart of the operation of the system; and

FIG. 2 shows a basic layout of the apparatus.

### DETAILED DESCRIPTION

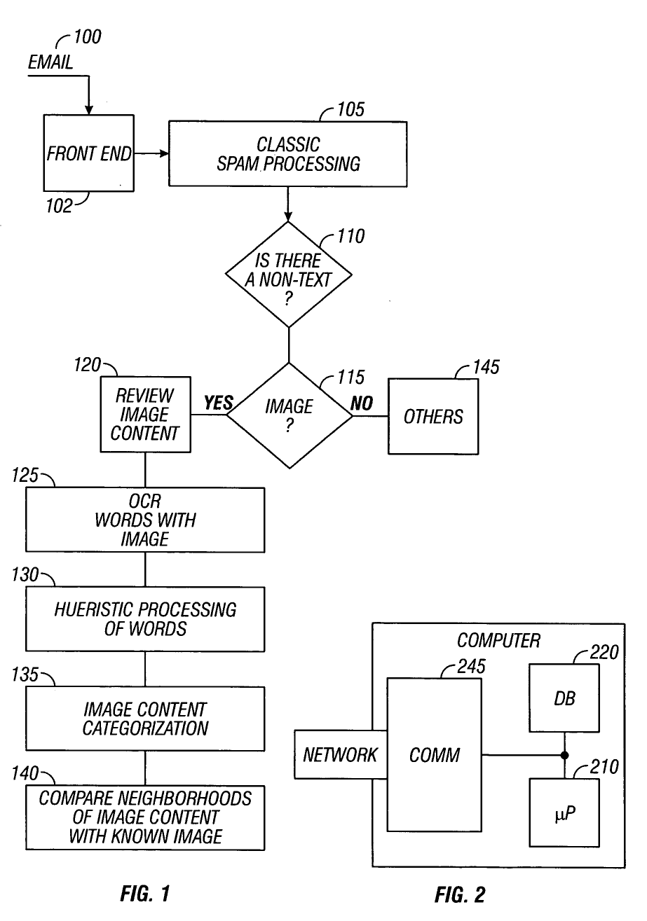

An embodiment using emails is described. An e-mail is received in the conventional way. FIG. 1 shows this e-mail 100 being received by a front and 102. The front end can be an e-mail program, or can be a dedicated gateway or preprocessor for an e-mail program such as a so called spam catcher program. The structure can be as shown in FIG. 2, where the communication is received over a network 200, e.g., the internet, or a telephone line, by a computer 205 that includes a processing part 210, e.g. a microprocessor, that processes the message. The computer receives the communication on a communication device 215, e.g. a network card or a modem or dedicated fax hardware, and processes the communication, as shown herein. A database 220 may be stored, e.g., in a memory, for use in the processing, as described. In the fax embodiment, the computer and processing part may be carried out by circuitry within the fax machine, or by a computer operating a fax program.

The preprocessor 102 first carries out classical spam processing on the e-mail. This may use any of the techniques described in my pending applications, and may also use any known technique such as heuristic processing, and/or Bayesian processing, to detect specified content within the e-mail.

If the classical processing determines that the message is not spam, flow passes to 110 which first determines whether there is a non-text portion to the e-mail. Of course, all emails will include headers, certain kinds of routing information, etc. The non-text portions of interest include things other than those headers, etc. This may be an attachment, an image or animation, sounds, any kind of executable code within the e-mail, or active content that will be viewed. In one aspect, specifically the aspect tested for at 115, the non-text portion is detected to be an image.

The mere detection of an image within e-mail does not signify that it is undesirable, however. For example, a family member may send an image based e-mail to another family member. The real question is whether the contents of the e-mail, and more specifically here, the contents of the image, are undesirable or not. Therefore, at 120, the image content is analyzed. The analysis includes preferably optically character recognizing words within the image, using conventional OCR techniques. Since the image is the same as any image which is conventionally OCRed, any OCR system can be used for this purpose.

After finding words within the image, 130 processes these words using text based spam processing techniques; e.g., it heuristically processes these words and/or Bayesian the processes these words, and may in fact use the same engine used in 105 to process the words to determine the presence of signs of undesirable content. If the image includes undesirable words, then the processing may signal undesired content, and end.

If not, content passes to 135, which carries out Image classification techniques. Examples of these prior techniques include U.S. Pat. Nos. 6,549,660, or 6,628,834, and many other articles in the literature, e.g., N. Vasconcelos and A. Lippman, “A Bayesian framework for semantic content characterization,” Proc. of IEEE Conf. on Computer Vision and Pattern Recognition, p. 566-71, 1999. Basically, this technique uses a catalog of image information to determine the category of the information which is being displayed in the image. The categorization may then be compared against known categories of undesirable information. As an example, sexually oriented content may be undesirable. Another category may include products for sale such as drugs (Viagra), or other products. If the image is categorized as having a category which is undesirable, then the communication is marked as spam, and fails.

At 140, the image is compared against portions of known undesirable images from known spam e-mails. A database of emails which are known to be spam is maintained. The known spam e-mails are categorized, and their associated images are also categorized. Spam e-mails are typically sent to a large number of recipients. When an image is found in one email that is known to be spam, the presence of the same image or image portion within another e-mail, signals that other email as being spam.

Accordingly, this may analyze different size neighborhoods of the image, and compare those different size neighborhoods against known image portions from known spam e-mails. The images may be compared on a bit by bit basis or byte by byte basis, using least mean squares processing or other image comparison techniques.

Alternatively, a hash function may be carried out on the image, to convert the image to a numerical score that represents the image content. That numerical score may be compared to other numerical scores from other images.

When the image is compressed, the contents of the image may first be converted to vectorized or bitmap form, prior to this calculation being carried out. This may facilitate the conversion and detection as described herein.

The image detection at 115 is only one of many different kinds of detection that can be made. For example, at 145, other non-text information is detected, such as ActiveX controls or other information which may include undesired content therein.

My pending application describes techniques of detecting spam signatures. For example, a user may be given the alternative to delete a specified e-mail while indicating that it is an undesired e-mail. That e-mail is then processed by the system, which compares the e-mail against various parameters. One of those comparisons may include a detection of the contents of the images within the e-mail. The entire image within an e-mail may be categorized, along with words within the image (detected by OCR as noted above), and also items within the image. Conventional techniques may be used to identify objects that are within the image, and to store those individual objects individually for use in detecting other e-mails. For example, a logo from a known company, may be stored as an object used to compare to other e-mails that are categorized later. As another example, pictures of sexual content, which are often repeated over and over again, may be individually stored in a database.

A signature e.g., a hash function, indicative of these pictures may also alternatively be stored.

The above has described use with emails. However, this system can also be used in determining and categorizing undesirable faxes. Undesired fax traffic is common. The same system noted above can be used, to OCR faxes and analyze the OCR'ed content; to analyze and categorize images within the faxes and determine if the category is undesirable; and/or to compare images in the faxes to images in a database. The fax machine may include a printer that prints faxes, and the system may prevent faxes which are determined to be spam, from being printed. Alternatively, the likely fax messages can be printed in a special way, or stored for later investigation, and forwarded to a mailbox or some other action.

Although only a few embodiments have been disclosed in detail above, other modifications are possible. For example, sounds, and other non text parts can be analyzed in a similar way to that described above. All such modifications are intended to be encompassed within the following claims:

1. A method comprising:
determining non-text parts in an electronic communication; and
analyzing said non text parts, to determine information in said non-text part which indicate that the electronic communication is an undesired communication.

2. A method as in claim 1, wherein said analyzing comprises analyzing an image as said non text part.

3. A method as in claim 2, wherein said analyzing comprises optically character recognizing words in said non text part, and analyzing said words to determine an undesired communication.

4. A method as in claim 3, further comprising analyzing text parts in the communication using a heuristic engine and wherein said analyzing said words comprises heuristic analysis of said words in said non-text part using the same heuristic engine.

5. A method as in claim 2, wherein said analyzing comprises automatically determining a category of the image by comparing the image with a catalog of image information that includes known image information therein, where said automatically determining determines multiple said categories, where at least one of the known information represents an undesired category, and determining if the category represents said undesired category.

6. A method as in claim 2, wherein said analyzing comprises determining a hash of at least portions of said image and comparing said hash of said portions of the image against other hashes of other at least portions of other images known to represent undesired content.

7. A method as in claim 5, wherein said comparing determines multiple different undesirable categories.

8. A system, comprising:
a communication device, which receives an electronic communication from a channel; and
a processing part, which processes said electronic communication, and analyzes a non-text part of the communication, to determine undesired communications.

9. A system as in claim 8, wherein said processing part includes a computer, which is programmed for said processing.

10. A system as in claim 8, wherein said processing part analyzes an image as said non text part.

11. A system as in claim 10, wherein said analyzes comprises optically character recognizing text within the image, and analyzing the optically character recognized text to determine that the communication is undesirable.

12. A system as in claim 10, wherein said analyzes comprises using the processing part to automatically categorize the image by comparing the image with a catalog of image information that includes known image information therein, where said automatically determining determines multiple said categories, where at least one of the known information represents an undesired category, and to use a category of the image to determine that the communication is undesirable.

13. A system as in claim 10, further comprising a database of image parts, at least some of said image parts representing images from known undesirable communications, wherein said analyzes comprises using the processing part to automatically compare the image to image parts in said database.

14. A system as in claim 8, wherein said processing part further includes a heuristic engine analyzing text parts in the communication and also analyzes said words comprises heuristic analysis of said words in said non-text part using the same heuristic engine.

15. A system as in claim 8, wherein said communication device includes fax hardware.

16. A facsimile apparatus, comprising:
a fax hardware part, having structure to receive facsimile communications; and
a fax contents processor, which analyzes a content of the communications, and determines if the communications is one which likely represents an undesirable communication, wherein said processor operates to obtain a hash of at least a portion of an image representing the facsimile communications, and to compare said hash to plural hashes of known undesirable images in a database to determine undesirable communications based on a match therebetween.

17. An apparatus as in claim 16, wherein said processor operates to prevent the facsimile from being automatically provided based on said determining that the communications is likely undesirable.

18. An apparatus as in claim 17, further comprising a printer that prints facsimile communications, and wherein said prevent comprises printing only communications which are not determined to represent undesirable communications.

19. An apparatus as in claim 16 wherein said fax contents processor processes a file indicative of an image representing the facsimile communication.

20. An apparatus as in claim 19, wherein said image is processed to optically character recognized text within the image, and to process the text to determine words which likely represent undesirable communications.

21. An apparatus as in claim 19, further comprising a memory storing image parts representing parts from known undesirable communications by comparing the image with a catalog of image information that includes known image information therein, where said automatically determining determines multiple said categories, where at least one of the known information represents an undesired category, and wherein said processor processes the image to compare parts of the image to said parts in said memory.
